(19) United States
(12) Patent Application Publication
(10) Pub. No.: US 2017/0039657 A1
(43) Pub. Date: Feb. 9, 2017

(54) HARVEST AMOUNT DISTRIBUTING METHOD, HARVEST AMOUNT INPUT METHOD, RECORDING MEDIUM, AND SYSTEM

(71) Applicant: FUJITSU LIMITED, Kawasaki-shi (JP)

(72) Inventors: Makoto HONDA, Odawara (JP); Daisuke KAWAI, Saitama (JP)

(73) Assignee: FUJITSU LIMITED, Kawasaki-shi (JP)

(21) Appl. No.: 15/258,498

(22) Filed: Sep. 7, 2016

Related U.S. Application Data
(63) Continuation of application No. PCT/JP2014/056690, filed on Mar. 13, 2014.

(51) Int. Cl. G06Q 50/02; G06Q 10/08

(52) U.S. Cl. CPC G06Q 50/02; G06Q 10/087

(57) ABSTRACT

A harvest amount distributing method includes receiving, by a computer, input of a harvest amount of a predetermined crop; referring to a recording device recording therein information of fields according to crop, and presenting the information of one or more of the fields corresponding to the predetermined crop, so as to enable selection, the referring and presenting being performed by the computer; and distributing the input harvest amount among the one or more of the fields selected, and recording each distributed harvest amount as a harvest amount of a corresponding field, the distributing and recording being performed by the computer.

### CROSS REFERENCE TO RELATED APPLICATIONS

This application is a continuation application of International Application PCT/JP2014/056690, filed on Mar. 13, 2014 and designating the U.S., the entire contents of which are incorporated herein by reference.

### FIELD

The embodiments discussed herein relate to a harvest amount distributing method, a harvest amount input method, recording medium and a system.

### BACKGROUND

To fulfill a shipping request for a crop, a worker has to go to multiple fields to harvest the amount to be shipped, when the amount cannot be obtained from a single field. In such a case, the harvest amount of the crop may be registered as the total amount harvested from multiple fields.

According to a related prior art, for example, quantities indicated in purchase data and sales data for products handled by differing product codes and quantity units are converted to quantities of the smallest basic unit for the product codes used in inventory management, whereby inventory information is updated. For example, refer to Japanese Laid-Open Patent Publication No. H11-203562.

### SUMMARY

According to an aspect of an embodiment, a harvest amount distributing method includes receiving, by a computer, input of a harvest amount of a predetermined crop; referring to a recording device recording therein information of fields according to crop, and presenting the information of one or more of the fields corresponding to the predetermined crop, so as to enable selection, the referring and presenting being performed by the computer; and distributing the input harvest amount among the one or more of the fields selected, and recording each distributed harvest amount as a harvest amount of a corresponding field, the distributing and recording being performed by the computer.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of a harvest amount distributing method according to an embodiment;

FIG. 2 is a diagram depicting an example of system configuration of a system 200;

FIG. 3 is a block diagram of an example of hardware configuration of a harvest amount distributing apparatus 100;

FIG. 4 is a block diagram of an example of hardware configuration of a client apparatus 201;

FIG. 5 is a diagram depicting an example of contents of a production plan DB 220;

FIG. 6 is a diagram depicting an example of contents of a units-of-storage master 230;

FIG. 7 is a diagram depicting an example of contents recorded in a harvest amount table 240;

FIG. 8 is a diagram depicting an example of a units-of-storage master maintenance screen;

FIG. 9 is a diagram depicting an example of a production plan registration screen;

FIG. 10 is a diagram depicting an example of a field selecting screen;

FIG. 11 is a diagram depicting an example of a harvest amount registration screen;

FIG. 12 is a block diagram of an example of a functional configuration of the harvest amount distributing apparatus 100;

FIG. 13 is a diagram of a screen change example of the harvest amount registration screen 1100;

FIG. 14 is a diagram of a screen change example of the harvest amount registration screen 1100;

FIGS. 15 and 16 are flowcharts of a procedure of a harvest amount distributing process of the harvest amount distributing apparatus 100; and

FIG. 17 is a flowchart of an example of details of a process procedure of a conversion ratio identifying process.

### DESCRIPTION OF THE INVENTION

Embodiments of a harvest amount distributing method, a harvest amount input method, a harvest amount distribution program, a harvest amount input program, and a system according to the present invention will be described in detail with reference to the accompanying drawings.

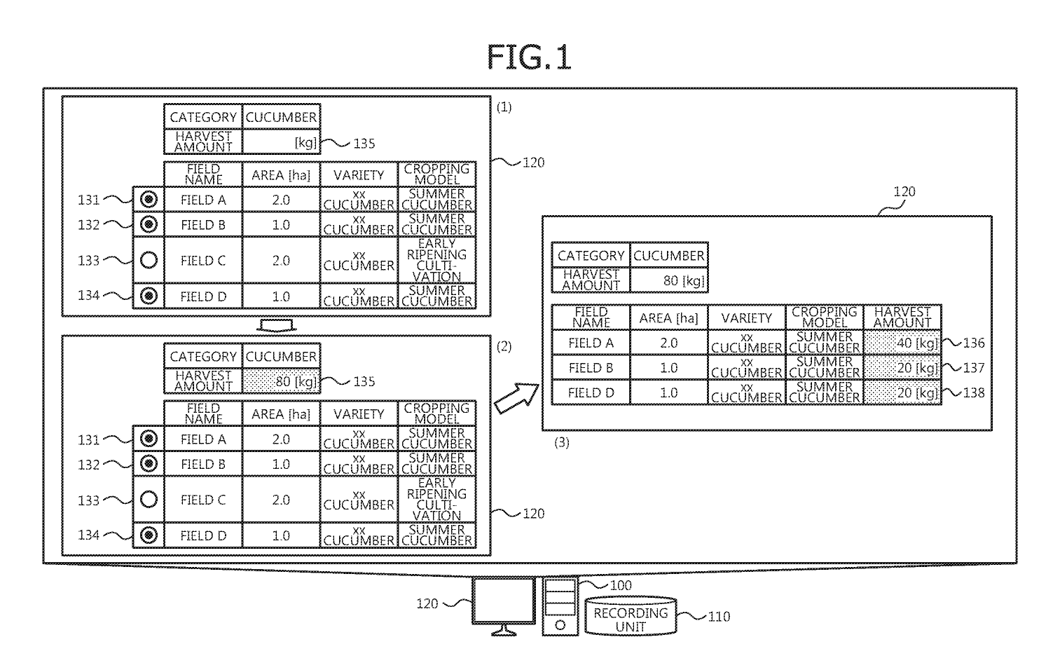

FIG. 1 is a diagram depicting an example of the harvest amount distributing method according to an embodiment. In FIG. 1, a harvest amount distributing apparatus 100 is a computer configured to distribute among one or more fields, a harvest amount of a crop harvested from the one or more fields. A field is farmland, cropland, etc. for cultivating and growing crops. A crop is a product produced by agriculture such as, for example, grains, vegetables, fruits, flowers, and ornamental plants. A harvest amount is a harvest of a crop, that is, the amount of a harvested crop.

Here, in response to a shipping request for a crop, a worker who performs harvesting operations may go to multiple fields to harvest the requested amount of the crop. For example, when a shipping request for 10 boxes of 2L-size cucumbers is received, the worker may go to multiple fields to selectively harvest 2L-size cucumbers of an amount to fill 10 boxes. In such a case, the crop harvest amount may be registered as a total amount of the crop harvested from the multiple fields.

In the analysis of cultivation efficiency, cultivation cost, etc. for each field related to the crop, the identification of information of the harvest amount for each field by a farm manager is important. Therefore, conceivably, for example, the worker who performs harvesting operations may weigh the harvest for each field and register the weight as the harvest amount of the field.

On the contrary, for a worker who performs the harvesting operations, registering the harvest amount of each field is burdensome. Furthermore, the worker may fail to register the harvest amount of a field. As described above, when 2L-size cucumbers are selectively harvested from multiple fields, the cucumbers may be collectively put in a single box or bag as the cucumbers are harvested and consequently, measuring the harvest amount of each field after harvesting is difficult.

Thus, in the present embodiment, the harvest amount distributing apparatus 100 distributes among one or more fields, the harvest amount of a crop harvested from the one or more fields and records the distributed harvest amounts as the harvest amounts of the corresponding fields. As a result, a rough harvest amount may be identified for each field, to support analysis of the cultivation efficiency, cultivation cost, etc. Hereinafter, an example of distribution of the harvest amount by the harvest amount distributing apparatus 100 will be described.

(1) The harvest amount distributing apparatus 100 refers to a recording unit 110 recording therein information of fields according to crop, and presents on a display 120 enabling selection, information of one or more fields corresponding to a certain crop. Here, the certain crop is a crop for which the harvest amount is to be distributed. The one or more fields corresponding to the certain crop are fields in which the certain crop is cultivated.

The information of the fields according to crop is associated with the fields and is information indicating the category, variety, cropping model, etc. of the crop planted in the fields. A category is the type of the crop. Varieties are types within a single category. A cropping model is a system indicating a combination of techniques and conditions for cultivating the crop.

In particular, for example, the harvest amount distributing apparatus 100 refers to the recording unit 110 and identifies one or more fields in which a crop of the same category as the certain crop is planted. The harvest amount distributing apparatus 100 presents on the display 120 enabling selection, information of the identified one or more fields.

In the example depicted in FIG. 1, the category of the certain crop is “cucumber” and information concerning the fields in which the crop of the category “cucumber” are planted is presented on the display 120 enabling selection. Here, the name and area (size) of a field, the variety of the crop of the category “cucumber” planted in the field, and the cropping model is shown as the information of the field.

In the display 120, the information of a related field may be selected by clicking on a check box 131 to 134 by a user input operation. In the example depicted in FIG. 1, a case is assumed where in fields A, B, and D among fields A to D, harvesting operations are performed for a crop of which the category is “cucumber”.

In this case, check boxes 131, 132, and 134 are clicked by a user input operation to select the information for the related fields A, B, and D. The display 120 may be that of the harvest amount distributing apparatus 100 or may be that of another computer.

(2) The harvest amount distributing apparatus 100 receives input of a harvest amount of the certain crop. Here, the input harvest amount is a total harvest amount of the certain crop harvested from one or more fields. In particular, for example, the harvest amount distributing apparatus 100 receives input of the harvest amount of the certain crop in units of weight.

The unit of weight, for example, may be kilograms (kg), tons (t), or pounds (lb). In the example depicted in FIG. 1, a harvest amount “80 [kg]” for a crop of which the category is “cucumber” has been input into column 135. The harvest amount (80 [kg]) is the total amount of the crop harvested from fields A, B, and D.

In the harvesting operations for the crop, a worker working in the field may put the harvested crop a designated box or bag and register the harvest amount of the harvested crop by the number of boxes or bags into which harvested crop was put, without paying attention to the weight of the harvested crop. Therefore, the harvest amount distributing apparatus 100, for example, may be configured to receive input of a value indicating in units of the boxes or bags into which the harvest crop is put, the harvest amount of the certain crop.

(3) The harvest amount distributing apparatus 100 distributes the input harvest amount among the selected one or more fields, and records the distributed harvest amounts as the harvest amount of the corresponding field. Here, the harvest amount of the crop cultivated in the field varies according to the area (size) of the field, i.e., the planting area of the crop cultivated in the field.

Therefore, according to the area of the selected fields A, B, and D, the harvest amount distributing apparatus 100, for example, may control the distribution amount of the harvest amount (80 [kg]) for the fields A, B, D. For example, the harvest amount distributing apparatus 100 controls the distribution amount of the harvest amount (80 [kg]) for the fields A, B, D in proportion to the area of the fields A, B, D.

In the example depicted in FIG. 1, the harvest amount (80 [kg]) of the crop is distributed among the fields A, B, D in proportion to the area of the fields A, B, D and recorded. Further, in the example depicted in FIG. 1, the harvest amounts (40 [kg], 20 [kg], 20 [kg]) distributed to each of the fields A, B, D are displayed in columns 136 to 138, respectively.

In this manner, according to the harvest amount distributing apparatus 100, information for one or more fields corresponding to the certain crop may be presented in a selectable manner on the display 120. As a result, the user may identify one or more fields in which a crop of the same category as that of the certain crop is cultivated and select one or more fields in which harvesting operations for the certain crop were performed.

Further, according to the harvest amount distributing apparatus 100, the input harvest amount may be distributed among the selected one or more fields and the distributed harvest amounts may be recorded as the harvest amounts for the corresponding fields. As a result, the user is able to identify a rough harvest amount of each field in which the certain crop is planted, which is helpful in the analysis of cultivation efficiency and cultivation cost for each field.

In the example depicted in FIG. 1, the harvest amount “40 [kg]” of cucumber harvested from field A, the harvest amount “20 [kg]” of cucumber harvested from field B, and the harvest amount “20 [kg]” of cucumber from field D may be identified, which is helpful in the analysis of cultivation efficiency and cultivation cost for each of the fields A, B, D.

A case where the harvest amount distributing apparatus 100 depicted in FIG. 1 is applied to a system 200 will be described.

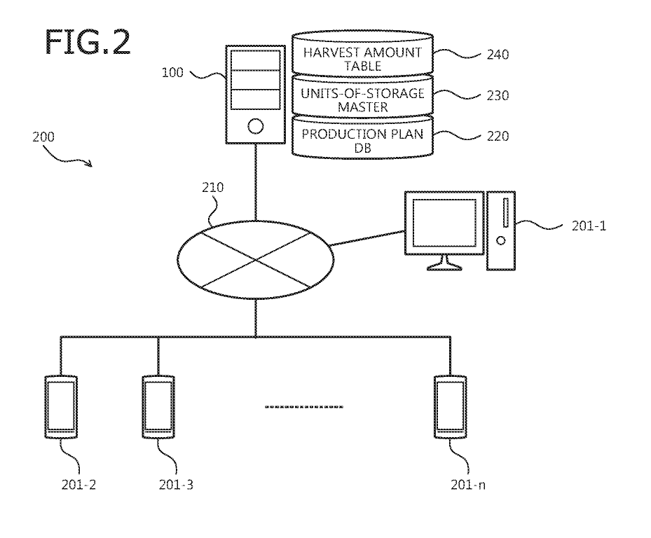

FIG. 2 is a diagram depicting an example of system configuration of the system 200. In FIG. 2, the system 200 is configured by the harvest amount distributing apparatus 100 and client apparatuses 201-1 to 201-n (n is a natural number of 2 or more). In the system 200, the harvest amount distributing apparatus 100 and the client apparatuses 201-1 to 201-n are connected through a network 210 that may be wired or wireless. The network 210, for example, is a local area network (LAN), a wide area network (WAN), or the Internet.

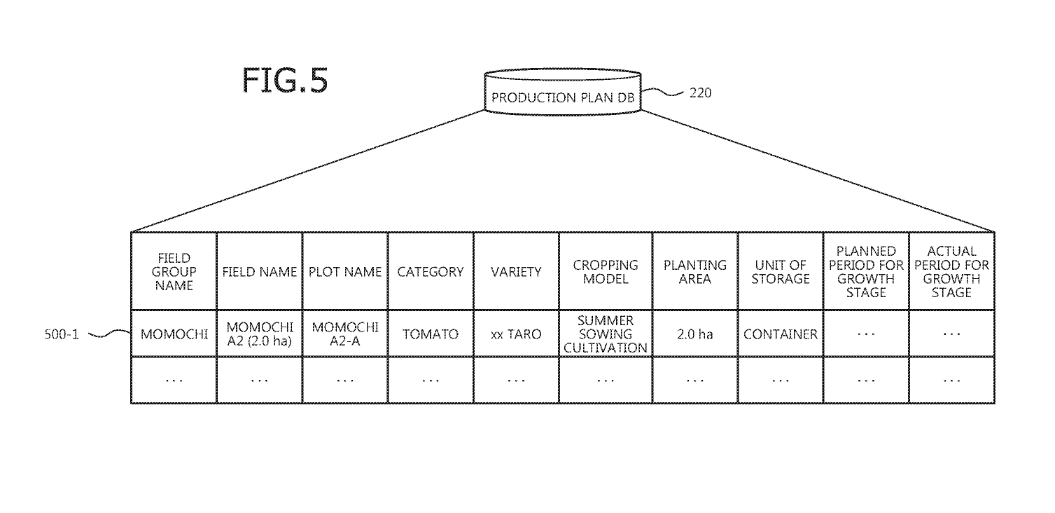

Here, the harvest amount distributing apparatus 100 has a production plan database (DB) 220, a units-of-storage master 230, and a harvest amount table 240, and performs display control of the client apparatuses 201-1 to 201-n. The harvest amount distributing apparatus 100, for example, is a server. Contents stored in the various DBs 220, 230, and 240 will be described with reference to FIGS. 5 to 7.

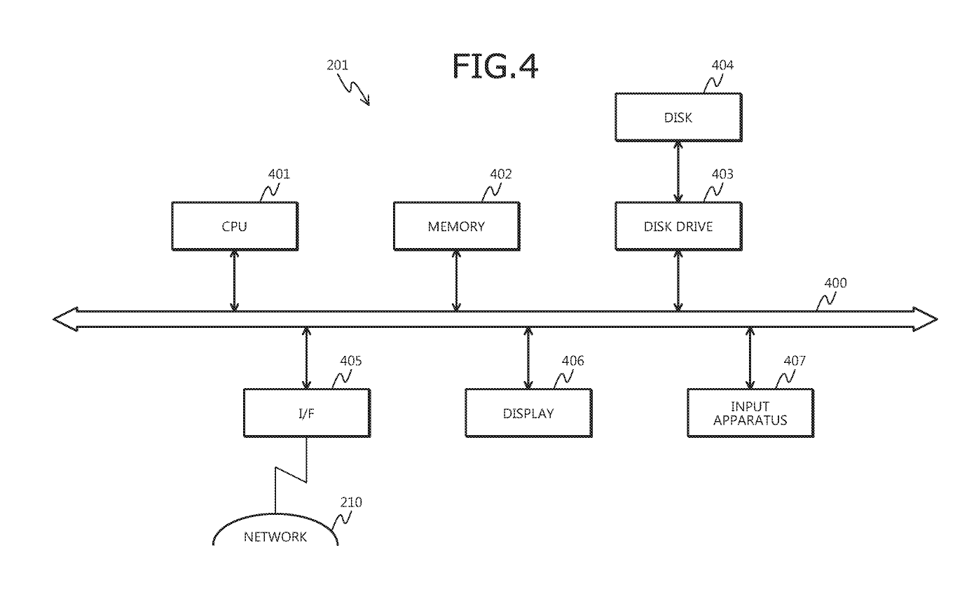

The client apparatuses 201-1 to 201-n have a display (for example, a display 406 depicted in FIG. 4 and described hereinafter) and are computers configured to display various screens under the display control of the harvest amount distributing apparatus 100. The client apparatuses 201-1 to 201-n, for example, are personal computers (PCs), note PCs, tablet PCs, smartphones, and the like used by the farm manager or workers involved in agricultural operations.

The various screens include, for example, a units-of-storage master maintenance screen, a production plan registration screen, a field selecting screen, and a harvest amount registration screen. A units-of-storage master maintenance screen is a screen for registering a conversion ratio of units of weight and units of storage for a crop. The production plan registration screen is a screen for registering a production plan for a crop. The field selecting screen is a screen for selecting a field from which a crop for which the harvest amount is to be registered has been harvested. The harvest amount registration screen is a screen for registering the harvest amount of a crop.

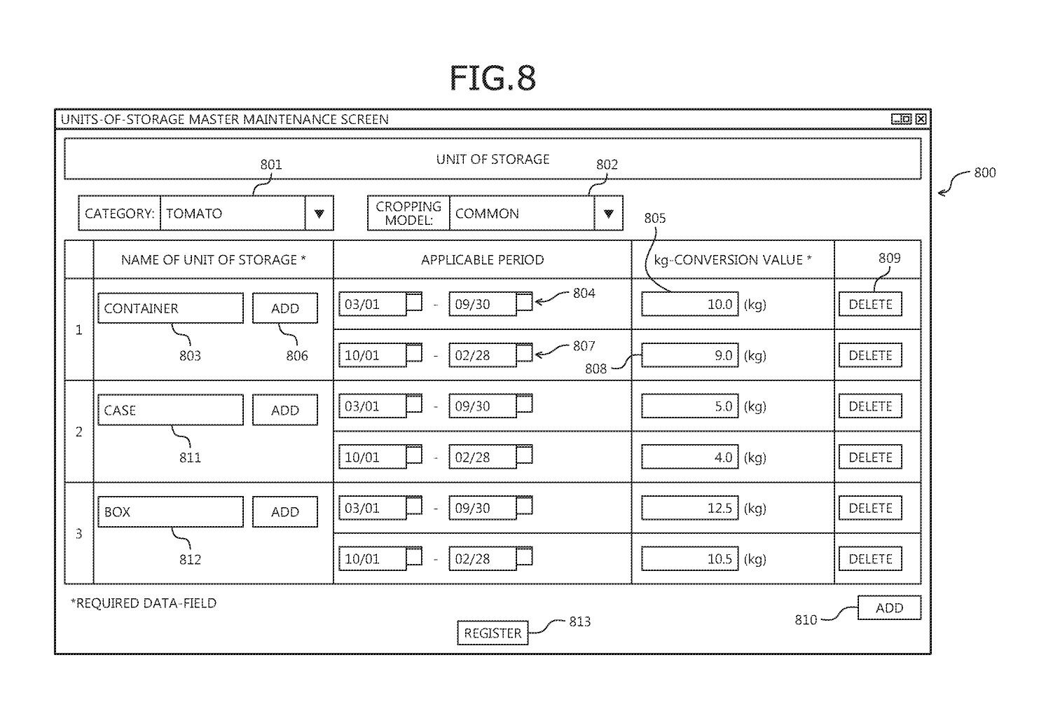

For example, the harvest amount distributing apparatus 100, when receiving a display request for various screens from the client apparatuses 201-1 to 201-n, generates screen information for the various screens and transmits the generated screen information to the client apparatuses 201-1 to 201-n. As a result, the various screens are displayed on the displays of the client apparatuses 201-1 to 201-n. An example of the various screens will be described with reference to FIGS. 8 to 11.

In the description hereinafter, the client apparatuses 201-1 to 201-n may be indicated as simply “client apparatus 201”.

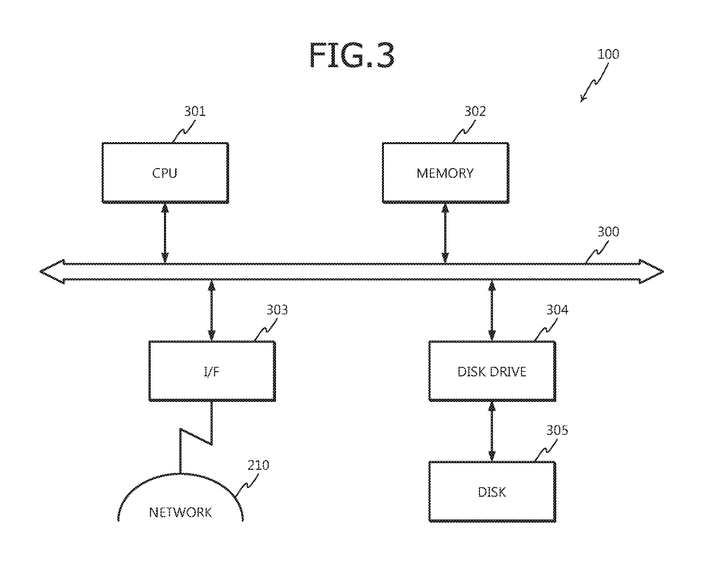

FIG. 3 is a block diagram of an example of hardware configuration of the harvest amount distributing apparatus 100. In FIG. 3, the harvest amount distributing apparatus 100 has a central processing unit (CPU) 301, memory 302, an interface (I/F) 303, a disk drive 304, and a disk 305. Respective components are connected by a bus 300.

Here, the CPU 301 governs overall control of the harvest amount distributing apparatus 100. The memory 302, for example, includes read-only memory, (ROM), random access memory (RAM), and flash ROM. In particular, for example, the flash ROM and ROM record various types of programs, and the RAM is used as a work area of the CPU 301. A program recorded in the memory 302 is loaded onto the CPU 301, whereby coded processes are executed by the CPU 301.

The I/F 303 is connected to the network 210 through a communications line and is connected other computers (for example, the client apparatus 201 depicted in FIG. 2) via the network 210. The I/F 303 administers an internal interface with the network 210 and controls the input and output of data from other computers. The I/F 303, for example, may be a modem, a LAN adapter, or the like.

The disk drive 304, under the control of the CPU 301, controls the reading and writing of data with respect to the disk 305. The disk 305 records data written thereto under the control of the disk drive 304. The disk 305, for example, may be a magnetic disk, an optical disk, and the like.

In addition to the components described, the harvest amount distributing apparatus 100 may further have, for example, a solid state drive (SSD), a keyboard, a mouse, a display, and the like.

FIG. 4 is a block diagram of an example of hardware configuration of the client apparatus 201. In FIG. 4, the client apparatus 201 has a CPU 401, memory 402, a disk drive 403, a disk 404, an I/F 405, the display 406, and an input apparatus 407. Respective components are connected by a bus 400.

Here, the CPU 401 governs overall control of the client apparatus 201. The memory 402, for example, includes ROM, RAM, and flash ROM. In particular, for example, the flash ROM and ROM record various types of programs, and the RAM is used as a work area of the CPU 401. A program recorded in the memory 402 is loaded onto the CPU 401, whereby a coded process is executed by the CPU 401.

The disk drive 403, under the control of the CPU 401, controls the reading and writing of data with respect to the disk 404. The disk 404 records data written thereto under the control of the disk drive 403. The disk 404, for example, may be a magnetic disk, an optical disk, and the like.

The I/F 405 is connected to the network 210 through a communications line and is connected to other computers (for example, the harvest amount distributing apparatus 100) via the network 210. The I/F 405 administers an internal interface with the network 210 and controls the input and output of data from other computers.

The display 406 displays data such as documents, images, and functional information, in addition to a cursor, icons, and toolboxes. The display 406, for example, may be a cathode ray tube (CRT) display, a liquid crystal display, an organic electroluminescence (EL) display, and the like. The display 406 corresponds to the display 120 depicted in FIG. 1.

The input apparatus 407 has keys for inputting text, numbers, various instructions, and the like, and performs data input. The input apparatus 407 may be a keyboard or a mouse, or may be a touch panel-type input pad or numeric pad.

Among the components above, the client apparatus 201 may omit, for example, the disk drive 403, the disk 404, and the like. Further, the client apparatus 201 may be configured to have, for example, a SSD, a scanner, a printer, and the like in addition to the components above.

Contents of the various DBs 220, 230, and 240 will be described with reference to FIGS. 5 to 7. The various DBs 220, 230, and 240, for example, are realized by the memory 302 and the disk 305 of the harvest amount distributing apparatus 100 depicted in FIG. 3.

FIG. 5 is a diagram depicting an example of the contents of the production plan DB 220. In FIG. 5, the production plan DB 220 has data-fields for field group names, field names, plot names, categories, varieties, cropping models, planting areas, units of storage, planned period for a growth stage, and actual period for a growth stage. Information is set into the data-fields, whereby production plan information (for example, production plan information 500-1) is stored as records.

Here, a production plan is a plan indicating in which field and how much of a crop that is to be produced is to be planted. A field group name is the name of a group to which collectively managed fields belong. A field name is the name of a field. A plot name is the name of a section into which a field is segmented and divided.

A category is the type of a crop such as, for example, tomato, paddy rice, cabbage, etc. A variety is a type within a single category. For example, among varieties of cabbage are summer-sown varieties such as “ayakaze” and “green ball”, spring-sown varieties such as “early cabbage No. 2”, “early cabbage No. 3”, “akiwasei”, “shinkaze”, etc. A cropping model is a system of a combination of techniques and conditions for cultivating a crop, such as, for example, direct seeding, transplanting, spring sowing cultivation, summer sowing cultivation, autumn sowing cultivation, winter sowing cultivation, and the like.

A planting area is the area (amount of land) for planting a crop. A unit of storage is a unit by which a harvested crop may be counted such as a bundle of the harvested crop or a receptacle into which the harvested crop is put and used in the harvesting operations. For example, a harvested crop may be counted in units of boxes, bags, containers, bundles, pieces, etc. A planned period for a growth stage is a planned period for each growth stage of a crop. An actual period for a growth stage is an actual period for each growth stage of a crop.

A growth stage indicates a growth phase of a crop. For example, growth stages of tomatoes include a seeding phase, a seedling growth phase, a planting phase, a growth phase, a flowering phase, a fruit growth phase, a harvest phase, etc. Although not depicted, other than the information described above, the production plan DB 220 may further record, for example, cultivation guidelines, planned cultivation start dates, planned cultivation end dates, cultivation periods, harvest amounts, selling unit price, amount of sales, etc. for a plan. The production plan DB 220 corresponds to the recording unit 110 depicted in FIG. 1.

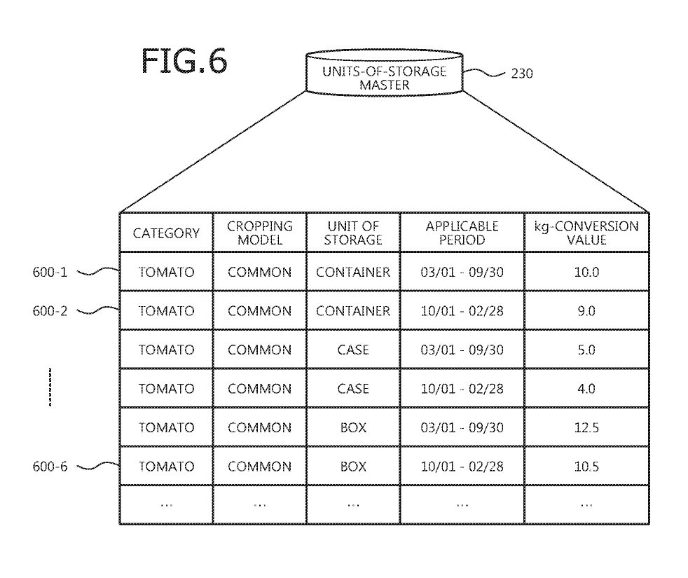

FIG. 6 is a diagram depicting an example of the contents of the units-of-storage master 230. In FIG. 6, the units-of-storage master 230 has data-fields for categories, cropping models, units of storage, applicable periods, and kg-conversion values. Information is set into the data-fields, whereby unit-of-storage information (for example, unit-of-storage information 600-1 to 600-6) is recorded as records.

Here, a category is a type of a crop. A cropping model is a system of a combination of techniques and conditions for cultivating a crop. A unit of storage is a unit by which a harvested crop may be counted such as a bundle of the harvested crop or a receptacle into which the harvested crop is put and used in the harvesting operations. An applicable period is a period to which a conversion ratio indicating a kg-conversion value is applicable. A kg-conversion value is a conversion ratio applied when a value indicating a harvest amount in a unit of storage is converted into kilograms, a unit of weight.

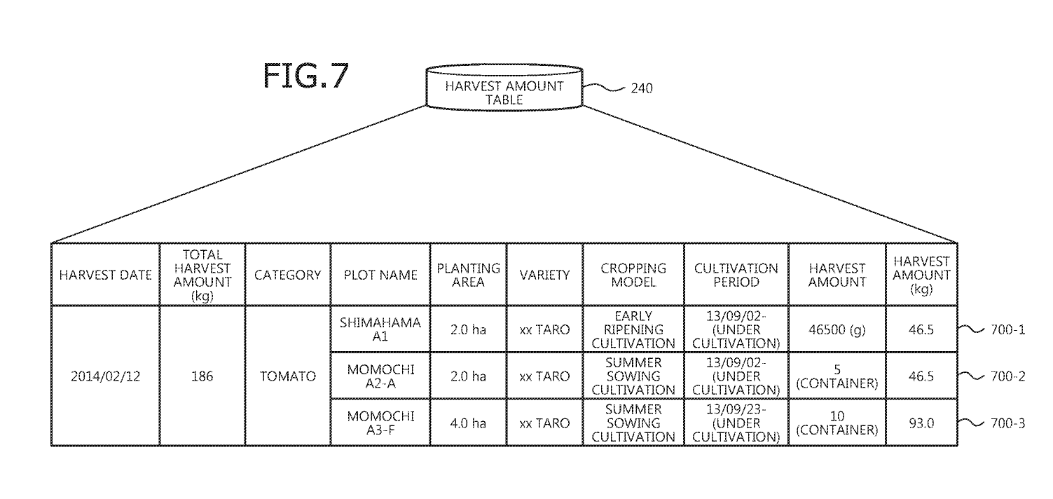

FIG. 7 is a diagram depicting an example of the contents recorded in the harvest amount table 240. In FIG. 7, the harvest amount table 240 records harvest amounts concerning crops for which a production plan has been created. The harvest amount table 240 has data-fields for harvest dates, total harvest amounts (kg), categories, plot names, planting areas, varieties, cropping models, cultivation periods, harvest amounts, and harvest amounts (kg). Information is set into the data-fields, whereby harvest amount information (for example, harvest amount information 700-1 to 700-3) is recorded as records.

Here, a harvest date is the year/month/day when a crop is harvested. A total harvest amount (kg) is the total amount of a crop harvested from one or more fields. A category is the type of a crop. A plot name is the name of a section into which a field is segmented and divided. A planting area is the area (amount of land) for planting a crop.

A variety is a type within a single category. A cropping model is a system of a combination of techniques and conditions for cultivating a crop. A cultivation period is a period during which a crop is cultivated. A harvest amount indicates a harvest amount of a crop in units of bags or boxes into which the harvested crop is put. A harvest amount (kg) indicates the harvest amount of a crop in a unit of kilograms.

For example, the harvest amount information 700-1 indicates the total harvest amount (kg) of a crop of the category “tomato” harvested on the harvest date “2014/02/12”. Further, the harvest amount information 700-1 indicates harvest amount “46500 (g)” and the harvest amount(kg) “46.5” on the harvest date “2014/02/12”, for a crop of the category “tomato” and the variety “xx Taro”, being cultivated in a field of the plot name “Shimahama A1” under the cropping model “early ripening cultivation”. Further, the harvest amount information 700-1 indicates for the field of the plot name “Shimahama A1”, the planting area “2.0ha” and the cultivation period “13/09/02-(under cultivation)”.

FIG. 8 is a diagram depicting an example of a units-of-storage master maintenance screen. In FIG. 8, a units-of-storage master maintenance screen 800 is a screen for registering for a crop, a conversion ratio for a unit of storage and a unit of weight. A units-of-storage master maintenance screen 800 is displayed on the display 406 of the client apparatus 201.

In a units-of-storage master maintenance screen 800, for example, the category of a crop may input when a user operates the input apparatus 407 of the client apparatus 201 depicted in FIG. 4 and clicks a box 801. In this example, the category “tomato” is input.

Further, the cropping model of a crop may be input when a box 802 is clicked. In this example, the cropping model “common” is input. Cropping model “common” means “common to all cropping models”. Further, a name of the unit of storage for a crop may be input when a box 803 is clicked. In this example, a name of the unit of storage “container” is input.

An applicable period in which a conversion ratio indicating a kg-conversion value is applicable may be input when a box 804 is clicked. In this example, an applicable period “03/01-09/30” is input. A kg-conversion value may be input when a box 805 is clicked. In this example, a kg-conversion value “10.0” is input.

Boxes for inputting an applicable period and a kg-conversion value may be added when an add button 806 is clicked. In this example, a box 807 for inputting an applicable period and a box 808 for inputting a kg-conversion value are added. Further, an applicable period “10/01-02/28” is input to the box 807 and a kg-conversion value “9.0” is input to the box 808.

The boxes 804, 805 may be deleted when a delete button 809 is clicked. Further, a box for inputting the name of the unit of storage may be added by clicking an add button 810. In this example, boxes 811, 812 for inputting a name of the unit of storage are added.

The various types of information input to a units-of-storage master maintenance screen 800 are transmitted from the client apparatus 201 to the harvest amount distributing apparatus 100 by when a register button 813 is clicked. As a result, unit-of-storage information based on the various types of information input to a units-of-storage master maintenance screen 800 is recorded to the units-of-storage master 230.

Thus, a units-of-storage master maintenance screen 800 enables a conversion ratio of a unit of storage and a unit of weight for a crop to be registered to the units-of-storage master 230 by an input of the category, the cropping model, a unit of storage, the applicable period, and the kg-conversion value. In the example depicted in FIG. 8, unit-of-storage information 600-1 to 600-6 depicted in FIG. 6 is recorded to the units-of-storage master 230.

In the description above, although an applicable period in which a conversion ratio indicating a kg-conversion value is applicable is input, configuration is not limited hereto. For example, input of an applicable period may be omitted by the user inputting a name of the unit of storage reflecting an applicable period in which a conversion ratio indicating a kg-conversion value is applicable.

For example, when a container used in harvesting operations during an applicable period “03/01-09/30” is called “summer container”, the user may input to the box 803, “summer container” as a the name of the unit of storage reflecting the applicable period “03/01-09/30”.

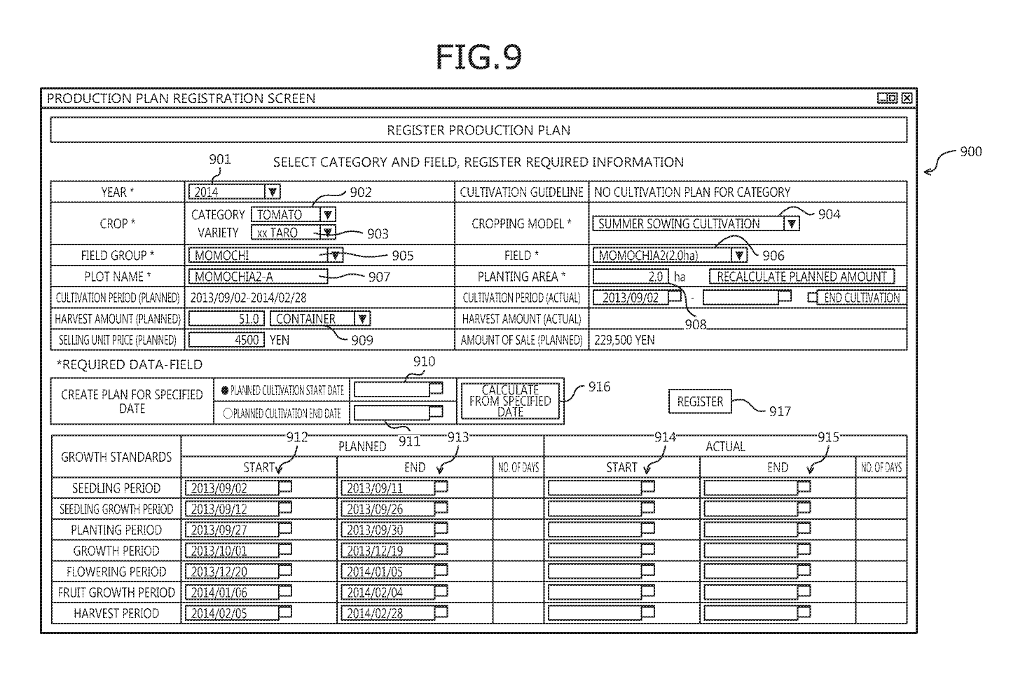

FIG. 9 is a diagram depicting an example of the production plan registration screen. In FIG. 9, a production plan registration screen 900 is a screen for registering a production plan for a crop to be produced. The production plan registration screen 900 is displayed on the display 406 of the client apparatus 201.

In the production plan registration screen 900, for example, the year in which a production plan is created may be input when a box 901 is clicked. In this example, a year “2014” is input. The category of a crop may be input when a box 902 is clicked. In this example, the category “tomato” is input.

The variety of a crop may be input when a box 903 is clicked. In this example, the variety “xx Taro” is input. A cropping model of a crop may be input when a box 904 is clicked. In this example, a cropping model “summer sowing cultivation” is input. A field group to which a field in which a crop is to be planted belongs may be input when a box 905 is clicked. In this example, the field group “momochi” is input.

A field in which a crop is to be planted may be input when a box 906 is clicked. In this example, a field “momochi A2(2.0ha)” is input. A plot name of a field in which a crop is to be planted may be input when a box 907 is clicked. In this example, a plot name “momochi A2-A” is input.

A planting area (amount of land) for planting a crop may be input when a box 908 is clicked. In this example, a planting area “2.0” is input. A name of the unit of storage of a crop may be input when a box 909 is clicked. The unit of storage of a crop, for example, is determined with consideration of the category of the crop, the planting area for the crop, etc. In this example, the name of the unit of storage “container” is input.

A planned cultivation start date for a crop may be input when a box 910 is clicked. A planned cultivation end date for a crop may be input when a box 911 is clicked. A start date for a planned period for a growth stage of a crop may be input when a box 912 is clicked.

An end date of a planned period for a growth stage for a crop may be input when a box 913 is clicked. In this example, respective start and end dates of a seedling period, a seedling growth period, a planting period, a growth period, a flowering period, a fruit growth period, and a harvest period are input as planned periods for growth stages of a crop.

The start date of the actual period for a growth stage may be input when a box 914 is clicked. The end date of the actual period for a growth stage may be input when a box 915 is clicked. When a button 916 is clicked, reference planned periods for growth stages of the crop are automatically calculated based on the planned cultivation start date or the planned cultivation end date, and start and end dates are input to boxes 912, 913.

The various types of information input to the production plan registration screen 900 is transmitted from the client apparatus 201 to the harvest amount distributing apparatus 100, when a register button 917 is clicked. As a result, production plan information based on the various types of information input to the production plan registration screen 900 are recorded to the production plan DB 220.

In this manner, the production plan registration screen 900 enables a production plan for a crop to be registered to the production plan DB 220 by an input of various types of information concerning a crop planned for cultivation. In the example depicted in FIG. 9, the production plan information 500-1 depicted in FIG. 5 is recorded to the production plan DB 220.

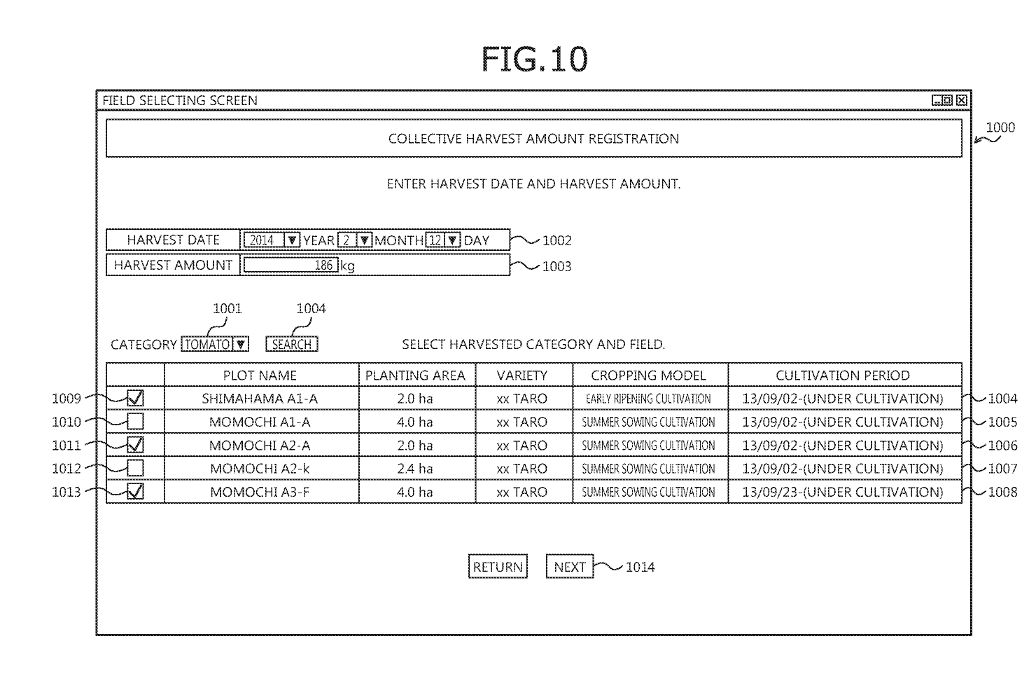

FIG. 10 is a diagram depicting an example of the field selecting screen. In FIG. 10, a field selecting screen 1000 is a screen for selecting a field from which a crop for which the harvest amount is to be registered, has been harvested. The field selecting screen 1000 is displayed on the display 406 of the client apparatus 201.

In the field selecting screen 1000, the category of a crop for which the harvest amount is to be registered may be input when a box 1001 is clicked. In this example, the category “tomato” is input. The harvest date when a crop was harvested may be input when a box 1002 is clicked. In this example, a harvest date “2014/02/12” is input.

A total harvest amount of a crop harvested from one or more fields on the harvest date input to the box 1002 may be input when a box 1003 is clicked. In this example, a harvest amount “186 [kg]” is input.

Input results input to the boxes 1001 to 1003 are transmitted from the client apparatus 201 to the harvest amount distributing apparatus 100, when a search button 1004 is clicked. As a result, at the harvest amount distributing apparatus 100, fields in which a crop for which the category is “tomato” is planted are searched for, and field information of retrieved fields is displayed on the field selecting screen 1000 enabling selection thereof. In the example depicted in FIG. 10, the field information 1004 to 1008 concerning fields in which tomatoes are under cultivation is displayed enabling selection.

The field information concerning a field from which the crop was harvested on the harvest date input to the box 1002 may be selected when a corresponding check box 1009 to 1013 for the field information 1004 to 1008 is clicked. For example, the user refers to the plot name, variety, cropping model, etc. in the field information 1004 to 1008 and selects field information concerning fields from which tomatoes where harvested on 2014/02/12. In the example depicted in FIG. 10, the field information 1004, 1006, and 1008 is selected.

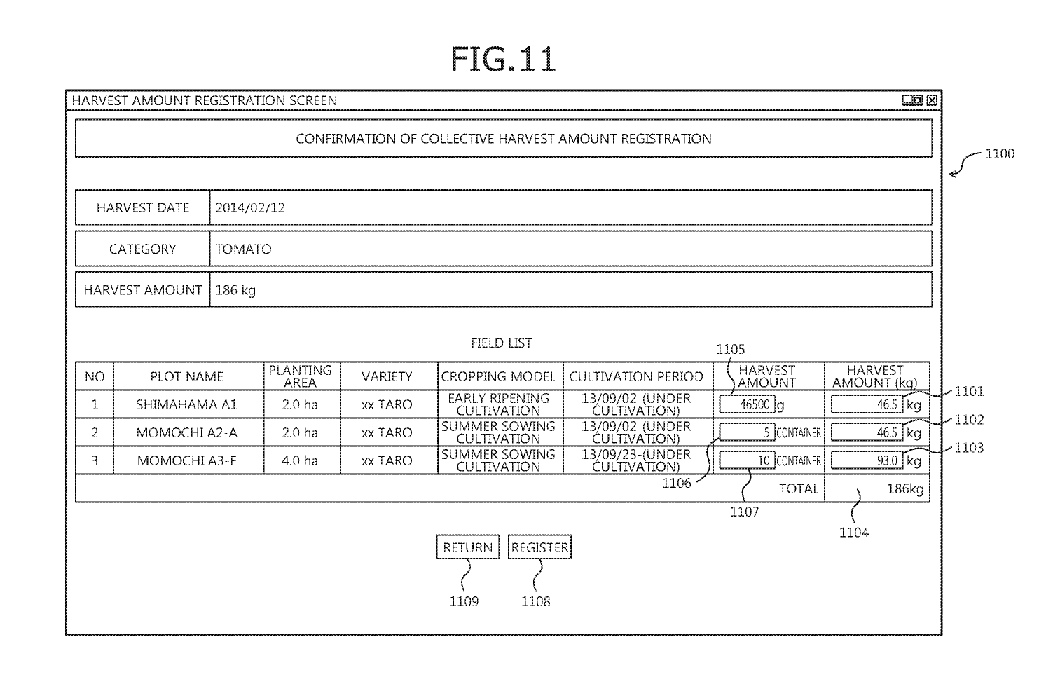

The harvest amount input to the box 1003 is distributed among the fields of the selected field information 1004, 1006, 1008, when a next button 1014 is clicked. A harvest amount registration screen 1100 (refer to FIG. 11 described hereinafter) indicating the distributed harvest amounts as the harvest amounts of the corresponding fields is displayed.

FIG. 11 is a diagram depicting an example of the harvest amount registration screen. In FIG. 11, the harvest amount registration screen 1100 is a screen for registering a harvest amount of a crop. The harvest amount registration screen 1100 is displayed on the display 406 of the client apparatus 201.

In the harvest amount registration screen 1100, the harvest amount “186 [kg]” of tomatoes harvested on 2014/02/12 is displayed. The harvest amount “186 [kg]” is the total harvest amount of tomatoes harvested from multiple fields on 2014/02/12.

In the harvest amount registration screen 1100, the contents of the field information 1004, 1006, 1008 selected in the field selecting screen 1000 (refer to FIG. 10) are displayed. As a result, fields from which tomatoes were harvested on 2014/02/12 may be identified.

In boxes 1101 to 1103, the harvest amount (46.5 [kg], 46.5 [kg], 93.0 [kg]) for each field are displayed. In box 1104, (186[kg]), which is the total harvest amount (kg) of the fields is displayed. Thus, 186 [kg], which is the total harvest amount of tomatoes harvested on 2014/02/12 may be distributed among the fields and the obtained harvest amounts may be identified.

In boxes 1105 to 1107, the harvest amounts converted from the harvest amount (kg) of the fields using a predetermined conversion ratio, into values indicated in a unit of storage are displayed. The values indicating the harvest amount in a unit of storage are rounded to the nearest whole number. Thus, the harvest amount of the fields may be identified by values indicated in a unit of storage such as a container or box used in the harvesting operations of a crop, and may be useful in judging the work performance a worker who performed the harvesting operations in the fields.

In the harvest amount registration screen 1100, the various types of harvest amount information input to the boxes 1101 to 1103, 1105 to 1107 are transmitted from the client apparatus 201 to the harvest amount distributing apparatus 100, when a register button 1108 is clicked. As a result, harvest amount information based on the various types of harvest amount information is recorded to the harvest amount table 240.

In this manner, the harvest amount registration screen 1100 enables harvest amounts for each field of a crop to be registered into the harvest amount table 240. In the example depicted in FIG. 11, the harvest amount information 700-1 to 700-3 depicted in FIG. 7 is recorded to the harvest amount table 240. In the harvest amount registration screen 1100, the field selecting screen 1000 may be returned to and reselection of the field information may be performed when a return button 1109 is clicked.

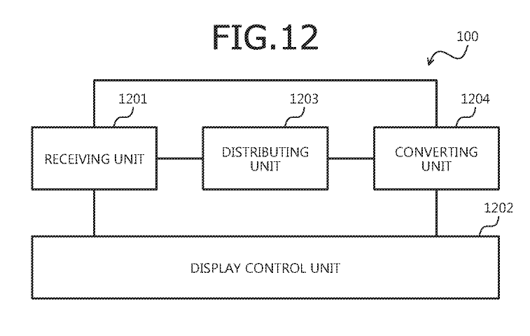

FIG. 12 is a block diagram of an example of a functional configuration of the harvest amount distributing apparatus 100. In FIG. 12, the harvest amount distributing apparatus 100 is configured by a receiving unit 1201, a display control unit 1202, a distributing unit 1203, and a converting unit 1204. The receiving unit 1201 to the converting unit 1204 are functions forming a control unit and, for example, are realized by executing on the CPU 301, a program recorded to a memory device such as the memory 302 and the disk 305 depicted in FIG. 3, or via the I/F 303. Process results of the functional units, for example, are recorded to a memory device such as the memory 302 and the disk 305.

The receiving unit 1201 receives input of a category, a harvest date, and a harvest amount of a certain crop. Here, the certain crop is a crop for which the harvest amount is to be registered. The category is the type of the certain crop. The harvest date is the day when the certain crop was harvested, for example, year/month/day. The harvest amount is the harvest amount of the certain crop. The input harvest amount, for example, is the total amount of the crop harvested from one or more fields for the harvest date.

In the description hereinafter, the total amount of a crop harvested from one or more fields may be indicated as “total harvest amount”. Further, the input total harvest amount is described taking a unit of weight such as kg as an example. Further, a value indicating the harvest amount by a unit of weight may be indicated as simply “weight value”.

The category, the harvest date, and the total harvest amount of the certain crop, for example, is input in the field selecting screen 1000 (refer to FIG. 10), by a user input operation of the client apparatus 201. The user, for example, is a worker who performed harvesting operations for the crop, a farm manager managing workers, and the like.

The client apparatus 201 transmits input results of the input category, harvest date, and total harvest amount to the harvest amount distributing apparatus 100. In this case, the receiving unit 1201, consequent to receiving the input results from the client apparatus 201, receives input of the category, the harvest date, and the total harvest amount of the certain crop.

The display control unit 1202 displays enabling selection, field information concerning one or more fields corresponding to the certain crop. For example, the display control unit 1202 obtains from the production plan DB 220, production plan information concerning one or more fields and in which the input category is set in the category data-field. As a result, one or more fields corresponding to the category of the certain crop, i.e., one or more fields in which a crop of the same category as the certain crop may be identified.

The display control unit 1202 refers to the obtained production plan information for the one or more fields and identifies field information concerning the one or more fields. The field information concerning the fields, for example, is information such as the field group name, the field name, the plot name, the category, the variety, the cropping model, the planting area, the unit of storage, and the cultivation period of the fields.

The display control unit 1202 displays on the display 406 enabling selection, the field information of the identified one or more fields. For example, the display control unit 1202 generates and transmits to the client apparatus 201, screen information of the field selecting screen 1000 that presents and enables selection of the field information concerning the one or more fields. As a result, the field information concerning one or more fields in which the certain crop is planted may be presented on the display 406 enabling selection.

The receiving unit 1201, among the identified one or more fields, receives selection of fields in which harvesting operations for the certain crop were performed on the input harvest date. The field selection, for example, is performed in the field selecting screen 1000 by a user input operation (refer to FIG. 10). The client apparatus 201 transmits a selection result of the selected fields to the harvest amount distributing apparatus 100. In this case, the receiving unit 1201 receives selection of a field by receiving the selection result from the client apparatus 201.

The distributing unit 1203 distributes the input total harvest amount among the selected one or more fields. For example, the distributing unit 1203 controls the distribution amount of the total harvest amount for the one or more fields in proportion to the planting area of the selected one or more fields. The planting area of the fields is the area (amount of land) in which the certain crop is planted and, for example, is identified from the production plan information of the fields.

For example, as depicted in FIG. 10, a case is assumed where in the field selecting screen 1000, the field information 1004, 1006, 1008 are selected. Further, the planting areas of the fields identified from the selected field information 1004, 1006, 1008 are assumed to be 2.0 [ha], 2.0 [ha], and 4.0 [ha], respectively.

In this case, the distributing unit 1203 divides the total harvest amount “186 [kg]” by the total planting area “8.0 [ha]” and multiplies the quotient “23.25 [kg/ha]” by the respective planting areas of the fields and thereby, calculates the harvest amount (kg) for each field. As a result, the harvest amounts (kg) of the fields identified by the field information 1004, 1006, 1008 are 46.5 [kg], 46.5 [kg], and 93.0 [kg], respectively.

The distributing unit 1203 records the harvest amounts distributed to the one or more fields as the harvest amounts in the corresponding fields. For example, the distributing unit 1203 records the distributed harvest amounts 46.5 [kg], 46.5 [kg], and 93.0 [kg] as the harvest amounts (kg) in the corresponding fields in the harvest amount table 24.

The display control unit 1202 displays the harvest amounts distributed to the one or more fields as the harvest amounts in the corresponding fields. For example, the display control unit 1202 generates screen information for the harvest amount registration screen 1100 (for example, refer to FIG. 11) displaying the harvest amounts distributed to the fields as the harvest amounts (kg) in the fields and transmits the generated screen information to the client apparatus 201.

As a result, the total harvest amount of the certain crop is distributed among the one or more fields in which harvesting operations for the crop were performed and the obtained harvest amounts may be displayed on the display 406 as the harvest amounts (kg) in the corresponding fields.

The converting unit 1204 converts the harvest amounts distributed to the one or more fields, i.e., the distributed weight values into values indicating the harvest amounts in the respective corresponding fields in units of storage. The unit of storage is a value measuring the amount of the harvested crop and, for example, is a unit by which a harvested crop may be counted such as a bundle of the harvested crop or a receptacle into which the harvested crop is put and used in the harvesting operations.

Here, when the categories of crops differ, the shapes and the densities of the crops may differ and the weights of the crops fitting into a single container or box used in the harvesting operations may change. For example, the density of tomatoes is higher than the density of green peppers and the weight of tomatoes fitting into a single container or box is greater than that of green peppers.

Therefore, the converting unit 1204, for example, may use a conversion ratio for the category of the crop to convert the distributed weight values into values indicating the harvest amounts in the corresponding fields in units of storage. The conversion ratio is a ratio of a value indicating the harvest amount of the certain crop in a unit of weight and a value indicating the harvest amount in a unit of storage. As a result, with consideration of shape and density, which vary consequent to the categories of crops differing, a value indicating the harvest amount of a crop by a unit of weight may be converted into a value indicating the harvest amount by a unit of storage.

Further, even when the categories of crops are the same, if the cropping model or harvesting period of the crops differ, the density of the crop may differ and the weight of the crop fitting into a single container or box may change. For example, the density of tomatoes is higher for tomatoes in the summer than in the winter. Consequently, the weight of summer tomatoes fitting in a single container or box is greater than that of winter tomatoes.

Therefore, the converting unit 1204, for example, may use a conversion ratio for the cropping model, the harvest date, or the planned harvest period of a crop to convert the distributed weight values into values indicating the weight values by a unit of storage. The cropping model or the planned harvest period of a crop, for example, is identified from the production plan information of the fields.

The production plan information 500-1 depicted in FIG. 5 will be described as an example. In this case, the converting unit 1204 refers to the production plan information 500-1, and identifies the category “tomato”, the cropping model “summer sowing cultivation”, and the unit of storage “container” of a crop.

The converting unit 1204 refers to the production plan information 500-1 and identifies the harvest period of the planned period for a growth stage or the actual period for the growth stage as the planned harvest period of the crop. In this example, the harvest period “2014/02/05 to 2014/02/28” of the planned period for a growth stage is assumed to be identified as the planned harvest period of the crop. Here, the converting unit 1204 may identify the input harvest date as the harvest date of the crop.

The converting unit 1204 extracts from the units-of-storage master 230, the unit-of-storage information 600-1, 600-2 corresponding to the identified category “tomato”, cropping model “summer sowing cultivation”, and unit of storage “container” of the crop. Next, the converting unit 1204 identifies among the extracted unit-of-storage information 600-1, 600-2, the unit-of-storage information that includes the harvest date or the planned harvest period of the crop in the applicable period.

Here, the converting unit 1204 identifies among the unit-of-storage information 600-1, 600-2, the unit-of-storage information 600-2, which includes the planned harvest period “02/05 to 02/28 in the applicable period. The converting unit 1204 refers to the identified unit-of-storage information 600-2 and identifies the kg-conversion value “9.0”. As a result, the kg-conversion value corresponding to the category, the cropping model, the harvest period, and the unit of storage of the crop may be identified.

The converting unit 1204 uses the conversion ratio indicated by the identified kg-conversion value and converts the distributed weight values into a values indicating the weight values in a unit of storage. As a result, with consideration of the density, which varies consequent to differences in the category, the cropping model, and the planned harvest period of crops, values indicating the harvest amount of the crops by a unit of weight may be converted into a value indicating the harvest amount by a unit of storage.

For example, as depicted in FIG. 11, the harvest amount (kg) distributed to the field of the plot name “momochi A2-A” is assumed to be “46.5 [kg]”. In this case, the converting unit 1204 divides the distributed harvest amount “46.5” by the identified kg-conversion value “9.0” and thereby, calculates the value “5” indicating the harvest amount in units of containers. This value is rounded to the nearest whole number.

The converting unit 1204 converts the distributed weight values and records the obtained values indicating the harvest amounts by a unit of storage, as the harvest amounts in the corresponding fields. For example, the distributing unit 1203 records the value “5”, which is obtained by conversion and indicates the harvest amount in units of containers, as the harvest amount in the field for which the plot name in the harvest amount table 240 is “momochi A2-A”.

The display control unit 1202 displays the values indicating the harvest amounts by a unit of storage, obtained by converting the distributed weight values. For example, the display control unit 1202 generates screen information of the harvest amount registration screen 1100 (for example, refer to FIG. 11) displaying as the harvest amounts in the fields, the values indicating the weight values distributed to the fields and obtained by converting the weight values, and transmits the generated screen information to the client apparatus 201.

Here, the display control unit 1202 outputs a column to receive input of a value indicated by a unit of storage, or a change, and further outputs, as the classification of the unit of storage to be displayed, the classification of a unit having the same classification as the unit of storage specified by the production plan. The classification of the unit of storage specified by the production plan, for example, is a classification of the unit of storage input to the box 909 on the production plan registration screen 900 depicted in FIG. 9 and is identified from the production plan information of the fields.

As a result, the values indicating the harvest amounts (kg) distributed to the one or more fields in which harvesting operations have been performed for the certain crop, obtained by conversion, may be displayed on the display 406 as the harvest amounts in the respective corresponding fields. Here, the classification of a unit that is the same as the classification of the unit of storage specified by the production plan may be applied as the classification of the unit of storage displayed with a column (for example, boxes 1106, 1107 depicted in FIG. 11) receiving input of a value indicated by a unit of storage, or a change.

The receiving unit 1201 receives a change of the displayed weight value of the field. Changes of weight values of the fields, for example, are performed in the harvest amount registration screen 1100 by user input operation of the client apparatus 201. The client apparatus 201 transmits a change result of the change performed for a weight value to the harvest amount distributing apparatus 100.

In this case, the receiving unit 1201 receives the change result from the client apparatus 201 and thereby, receives changes of the weight values of the fields. A change of a weight value of a field, for example, is performed when the harvest amount (kg) of the field displayed on the harvest amount registration screen 1100 is judged to differ from the actual weight of the crop harvested from the field.

The converting unit 1204, when a displayed weight value of a field has been changed, may convert the changed weight value into a value indicating the harvest amount by a unit of storage. For example, the converting unit 1204 uses a conversion ratio indicated by a kg-conversion value identified from the units-of-storage master 230 to convert the changed weight value into a values indicating the harvest weight by a unit of storage.

The display control unit 1202, when the displayed weight value of a field has been changed, may change the value indicating the harvest amount of the field by a unit of storage to a value indicating the changed weight value by a unit of storage, obtained by conversion. For example, the display control unit 1202 performs control to change the value indicating the harvest amount by a unit of storage on the harvest amount registration screen 1100 to a value indicating the changed harvest amount (kg) by a unit of storage, obtained by conversion.

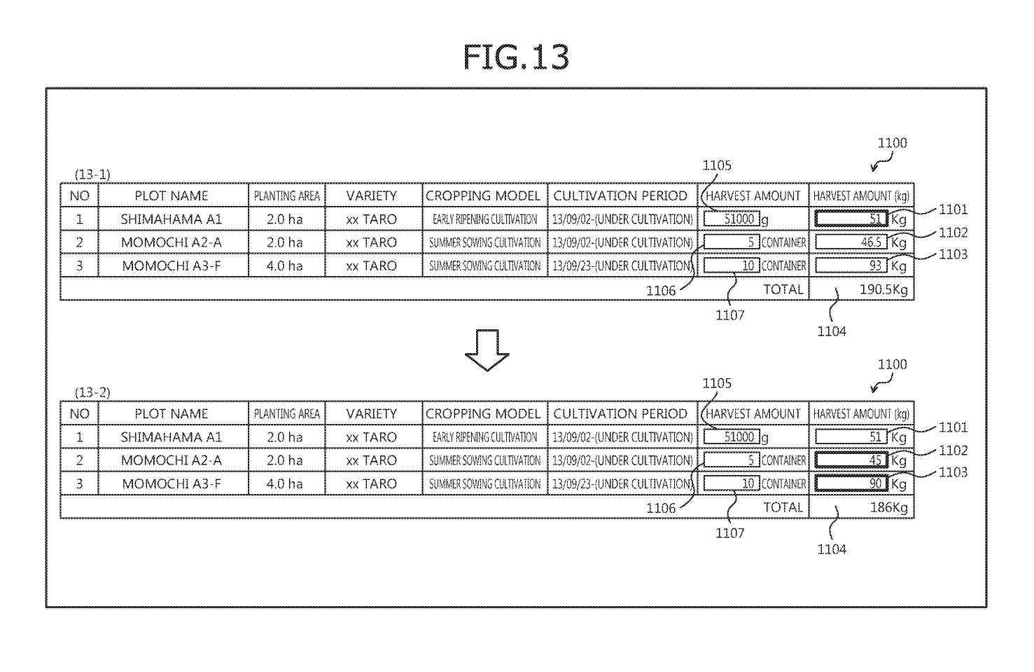

An example of screen change of the harvest amount registration screen 1100 in a case where the weight value of a field has been changed will be described with reference to FIG. 13.

The display control unit 1202, when the displayed weight value of a field has been changed, records to the harvest amount table 240 as the harvest amount in the corresponding field, the changed weight value and the value indicating the changed weight value by a unit of storage, obtained by conversion. As a result, a change concerning the harvest amount of a field may be reflected in the harvest amount table 240.

The receiving unit 1201 receives the change of the displayed value indicating the harvest amount of the field by a unit of storage. A change of a value indicating the harvest amount of a field by a unit of storage, for example, is performed in the harvest amount registration screen 1100 by user input operation of the client apparatus 201. The client apparatus 201 transmits the change result of the value indicating the changed harvest amount by a unit of storage to the harvest amount distributing apparatus 100.

In this case, the receiving unit 1201 receives the change result from the client apparatus 201 and thereby, receives a change of a value indicating the harvest amount of a field by a unit of storage. A change of a value indicating the harvest amount of a field by a unit of storage, for example, is performed when a displayed value indicating the harvest amount by a unit of storage is judged to differ from a value recorded by a worker who performed harvesting operations in the field or a value registered by the worker.

The converting unit 1204, when the displayed value indicating the harvest amount of the field by a unit of storage has been changed, may convert the changed value indicating the harvest amount by a unit of storage to a weight value. For example, the converting unit 1204 uses a conversion ratio indicated by a kg-conversion value identified from the units-of-storage master 230 to convert the changed value indicating the harvest amount by a unit of storage to a weight value.

The display control unit 1202, when the displayed value indicating the harvest amount of the field by a unit of storage has been changed, may change the weight value of the field to a weight value obtained by converting the changed value indicating the harvest amount by a unit of storage. For example, the display control unit 1202 performs control to change the harvest amount (kg) on the harvest amount registration screen 1100 to a weight value indicating the changed value indicating the harvest amount by a unit of storage, obtained by conversion.

A screen change example of the harvest amount registration screen 1100 in a case where a value indicating a harvest amount of a field by a unit of storage has been changed.

The display control unit 1202, when a displayed value indicating a harvest amount of a field by a unit of storage has been changed, records to the harvest amount table 240 as the harvest amount in the corresponding field, the changed value indicating the harvest amount by a unit of storage and a weight value obtained by converting the changed value indicating the harvest amount by a unit of storage. As a result, the change concerning the harvest amount of the field may be reflected in the harvest amount table 240.

In the description, although values indicating by a unit of storage, the harvest amounts obtained by converting distributed weight values are displayed, configuration is not limited hereto. For example, configuration may be such that the converting unit 1204 does not convert the distributed weight values, or the display control unit 1202 does not display the values indicating the harvest amounts by a unit of storage, obtained by conversion.

In this case, configuration may be such that the receiving unit 1201 receives input of values indicating the harvest amounts by a unit of storage corresponding to the distributed weight values. Here, as described above, as the classification of the unit of storage displayed together with the column receiving input of values indicating the harvest amounts by a unit of storage, the classification of a unit that is the same as the unit of storage specified by the production plan is applied, enabling the input of harvest amounts by the user to be facilitated.

The converting unit 1204 may convert a value indicating the harvest amount by an input unit-of-storage corresponding to the distributed weight value, to a weight value. The display control unit 1202 may change the distributed weight value to a weight value obtained by converting the value indicating the harvest amount by the input unit-of-storage.

In the description, although an example is given of a case where input of a value indicating the total harvest amount of a crop by a unit of weight is received, configuration is not limited hereto. For example, the receiving unit 1201 may be configured to receive a value indicating the total harvest amount of a crop by a unit of storage. In this case, the distributing unit 1203 distributes a value indicating the input total harvest amount by a unit of storage among the selected one or more fields.

A screen example of the harvest amount registration screen 1100 will be described using the harvest amount registration screen 1100 depicted in FIG. 11. Here, the harvest amount registration screen 1100 depicted in FIG. 11 enables, based on the harvest amount (kg) obtained by proportionately dividing the total harvest amount of the crop according to area, identification of the harvest amount of each field by a unit of weight and evaluation of the harvest amount, yield, etc., without actually measuring the weight of the crop harvested from each field. Here, the yield is the harvest of a crop per unit of farmland. The unit of farmland may be expressed, for example, as 10 are (a).

The harvest amount registration screen 1100 enables the work performance of a worker who performed harvesting operations in fields to be evaluated based on the values indicating the harvest amounts by a unit of storage, obtained by converting the harvest amounts (kg) of the field. Hereinafter, a screen change example in a case where various types of harvest amounts are corrected in the harvest amount registration screen 1100 will be described.

FIG. 13 is a diagram of a screen change example of the harvest amount registration screen 1100. Here, a screen change example of the harvest amount registration screen 1100 in a case where a value indicating the harvest amount of a crop by a unit of weight is changed will be described. In FIG. 13, a portion of the harvest amount registration screen 1100 is displayed.

In this example, the actual measured harvest amount (kg) of tomatoes harvested on 2014/02/12, in a field of the plot name “Shimahama A1”field is assumed to be 51 [kg] and therefore, the harvest amount (kg) of the tomatoes harvested in the field of the plot name “Shimahama A1” is assumed to be corrected.

(13-1) In the harvest amount registration screen 1100, by user input operation, the value in the box 1101 indicating, by a unit of weight, the harvest amount of tomatoes harvested in the field of the plot name “Shimahama A1” has been changed to 51 [kg]. In this case, the display control unit 1202, in response to the change of the value in the box 1101, changes the value in the box 1104 summing the harvest amounts (kg) of the fields to 190.5 [kg]. The display control unit 1202, in response to the change of the value in the box 1101, changes the value in the box 1105 to 51000 [g].

Next, a case is assumed where corresponding a total harvest amount “186 [kg]” of the tomatoes, the harvest amount (kg) of the tomatoes harvested in the field of the plot name “momochi A2-A” and the harvest amount (kg) of the tomatoes harvested in the field of the plot name “momochi A3-F” are adjusted.

(13-2) In the harvest amount registration screen 1100, by user input operation, the value in box 1102 indicating, by a unit of weight, the harvest amount of tomatoes harvested in the field of the plot name “momochi A2-A” is changed to 45 [kg]. Further, the value in the box 1103 indicating, by a unit of weight, the harvest amount of tomatoes harvested in the field of the plot name “momochi A3-F” is changed to 90 [kg].

In this case, the display control unit 1202, in response to the changes of the values in the boxes 1102, 1103, changes the value of the box 1104 summing the harvest amounts (kg) of the fields to 186 [kg]. The display control unit 1202 changes the value “5” indicating, in units of containers, the harvest amount of tomatoes harvested in the field of the plot name “momochi A2-A” to a value indicating the changed weight value “45 [kg]” in units of containers, obtained by conversion. Similarly, the display control unit 1202 changes the value “10” indicating, in units of containers, the harvest amount of tomatoes in the field of the plot name “momochi A3-F” to a value indicating the changed weight value “90 [kg]” in units of containers, obtained by conversion.

In the example depicted in FIG. 13, the values for both the field of the plot name “momochi A2-A” and the field of the plot name “momochi A3-F”, indicating the changed weight value in units of containers, obtained by conversion are the same values as before conversion. Therefore, the values in the boxes 1106, 1107 are not changed.

In this manner, the harvest amount registration screen 1100 enables the user of the client apparatus 201 to identify a rough harvest amount (kg) for each field in which harvesting operations for tomatoes were performed on 2014/02/12. Further, based on the actual measured harvest amount (kg) of tomatoes harvested in the field of the plot name “Shimahama A1” may be corrected.

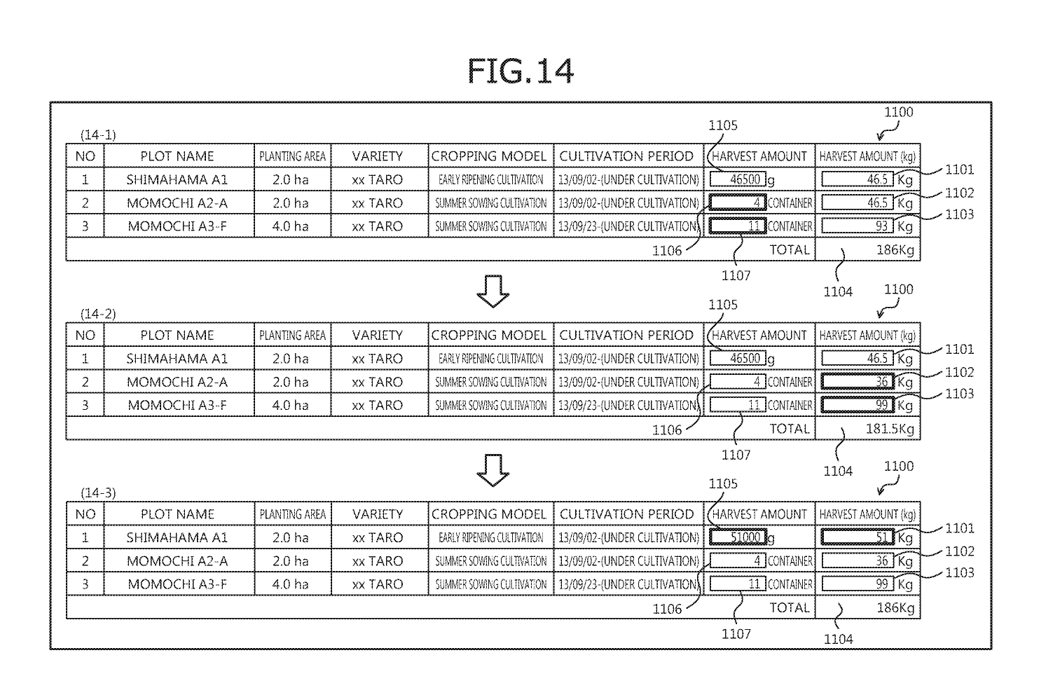

FIG. 14 is a diagram of a screen change example of the harvest amount registration screen 1100. Here, a screen change example of the harvest amount registration screen 1100 in a case where the value indicating the harvest amount of a crop in a unit of storage will be described. In FIG. 14, a portion of the harvest amount registration screen 1100 is displayed.

In this example, a container count recorded by a worker (or, a container count registered by a worker) who performed harvesting operations in the field of the plot name “momochi A2-A” on 2014/02/12 assumed to be “4” and therefore, the harvest amount of tomatoes harvested in the field of the plot name “momochi A2-A” is assumed to be corrected.

Further, a container count recorded by a worker (or, a container count registered by a worker) who performed harvesting operations in the field of the plot name “momochi A3-F” on 2014/02/12 assumed to be “11” and therefore, the harvest amount of tomatoes harvested in the field of the plot name “momochi A3-F” is assumed to be corrected.

In other words, case will be described where a container count remembered by a worker who performed harvesting operations in the fields is used as clue and total harvest amount “186 [kg]” of tomatoes is proportionately divided according to area and obtained harvest amounts for the fields are corrected.

(14-1) In the harvest amount registration screen 1100, by user input operation, the value in the box 1106 indicating the harvest amount of tomatoes harvested in the field of the plot name “momochi A2-A” is changed to “4”. In this case, the converting unit 1204 uses a predetermined conversion ratio to convert the changed value indicating the harvest amount in units of containers into a value indicating the harvest amount in a unit of weight.

For example, the converting unit 1204 refers to the units-of-storage master 230 and identifies the kg-conversion value corresponding to the category, the cropping model, the harvest period, and the unit of storage of the crop. In this example, the kg-conversion value “9.0” is identified. The converting unit 1204 multiplies the changed value “4” indicating the harvest amount in units of containers by the kg-conversion value “9.0” and thereby, calculates a value “36” indicating the harvest amount by a unit of weight.

In the harvest amount registration screen 1100, by user input operation, the value in the box 1107 indicating the harvest amount of tomatoes in the field of the plot name “momochi A3-F” is changed to “11”. In this case, the converting unit 1204 multiplies the changed value “11” indicating the harvest amount in units of containers by the kg-conversion value “9.0” and thereby, calculates a value “99” indicating the harvest amount by a unit of weight.

(14-2) In the harvest amount registration screen 1100, corresponding to the change of the values in the boxes 1106, 1107, the values in the boxes 1102, 1103 are changed. For example, the display control unit 1202, in response to the change of the value in the box 1106, changes the value in the box 1102 to a weight value “36” obtained by converting the changed value “4” indicating the harvest amount in units of containers. Further, the display control unit 1202, in response to the change of the value in the box 1107, changes the value in the box 1103 to the weight value “99” obtained by converting the changed value “11” indicating the harvest amount in units of containers.

Corresponding the total harvest amount “186 [kg]” of tomatoes, the harvest amount (kg) of tomatoes harvested in the field of the plot name “Shimahama A1” is assumed to be adjusted.

(14-3) In the harvest amount registration screen 1100, by user input operation, the value in the box 1101 indicating, by a unit of weight, the harvest amount of tomatoes harvested in the field of the plot name “Shimahama A1” is changed to 51 [kg]. In this case, the display control unit 1202, in response to the change of the value in the box 1101, changes the value in the box 1104 summing the harvest amounts (kg) of the fields to “186 [kg]. Further, the display control unit 1202, in response to the change of the value in the box 1101, changes the value in the box 1105 to 51000 [g].

In this manner, the harvest amount registration screen 1100 enables a container count remembered by a worker who performed harvesting operation in the fields on 2014/02/12 to be used as clue to correct rough harvest amounts of the fields, obtained by proportionately dividing the total harvest amount according to area, to be values closer to the actual measured value.

Changing a value indicating the harvest amount of a certain field by a unit of weight is performed in a case where the weight of the crop harvested in the field is properly measured. Therefore, configuration may be such that if the value indicating the harvest amount of the field by a unit of storage is changed after the value indicating the harvest amount of the certain field has changed, the converting unit 1204 may refrain from performing conversion to a weight value corresponding to the changed value indicating the harvest amount by a unit of storage. As a result, the correct weight of the crop harvested in the field can be prevented from being changed as a result of the harvest amount of the certain field being changed corresponding to the change of the value indicating the harvest amount by a unit of storage.

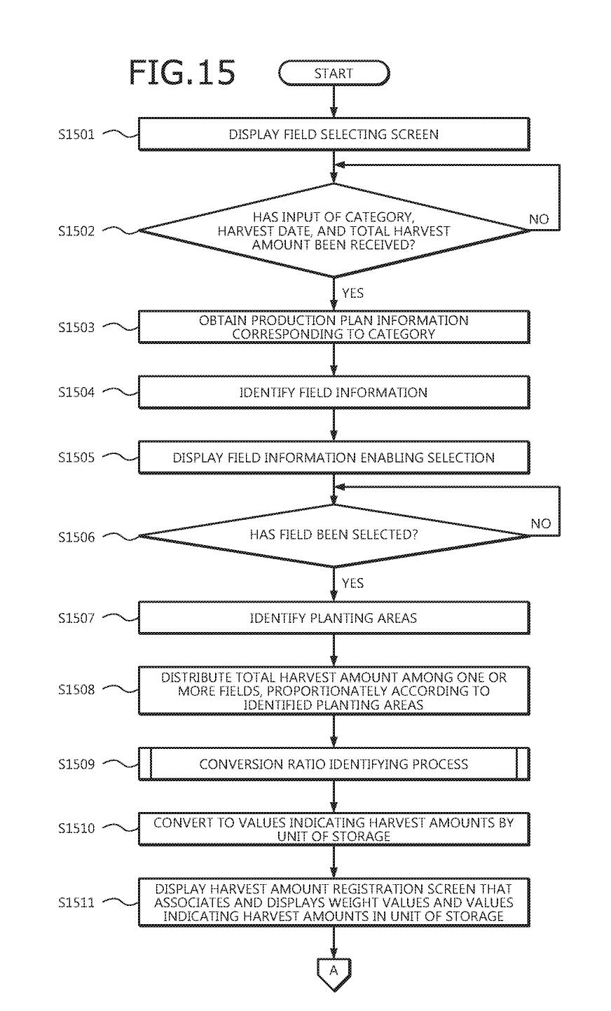

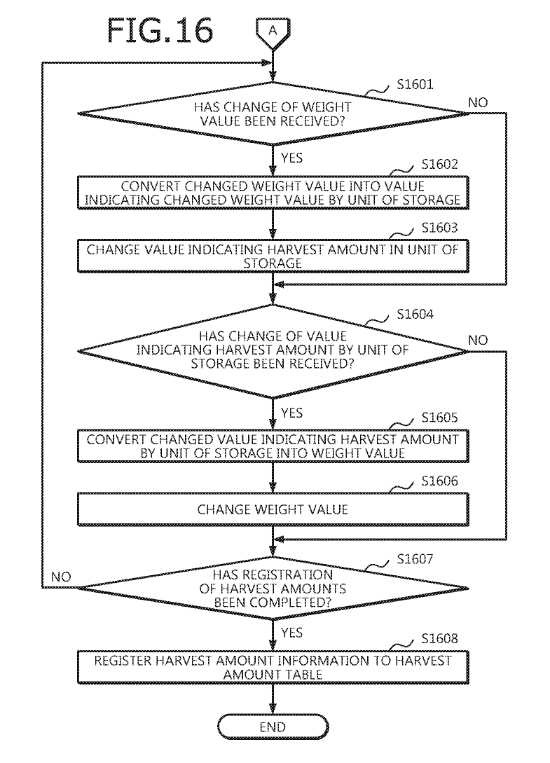

FIGS. 15 and 16 are flowcharts of a procedure of a harvest amount distributing process of the harvest amount distributing apparatus 100. In the flowchart depicted in FIG. 15, the harvest amount distributing apparatus 100 displays on the display 406, the field selecting screen (for example, the field selecting screen 1000) for selecting a field in which a certain crop is harvested (step S1501).

The harvest amount distributing apparatus 100 determines whether input of the category, the harvest date, and the total harvest amount of a certain crop has been received (step S1502). Here, the harvest amount distributing apparatus 100 stands by for receipt of input of the category, the harvest date, and the total harvest amount (step S1502: NO).

When input of the category, the harvest date, and the total harvest amount has been received (step S1502: YES), the harvest amount distributing apparatus 100 obtains from the production plan DB 220, the production plan information of one or more fields corresponding to the input category (step S1503).

The harvest amount distributing apparatus 100 refers to the obtained production plan information of the one or more fields and identifies the field information of the one or more fields (step S1504). The harvest amount distributing apparatus 100 displays the identified field information of the one or more fields on the display 406 to enable selection (step S1505).

The harvest amount distributing apparatus 100 determines whether one or more fields in which harvesting operations for the certain crop were performed on the input harvest date has been selected (step S1506). Here, the harvest amount distributing apparatus 100 stands by for selection of one or more fields (step S1506: NO).

When one or more fields have been selected (step S1506: YES), the harvest amount distributing apparatus 100 refers to the field information of the one or more fields, and identifies the planting areas of the one or more fields (step S1507). The harvest amount distributing apparatus 100 distributes the input total harvest amount among the one or more fields, proportionately according to the identified planting areas of the one or more fields (step S1508).

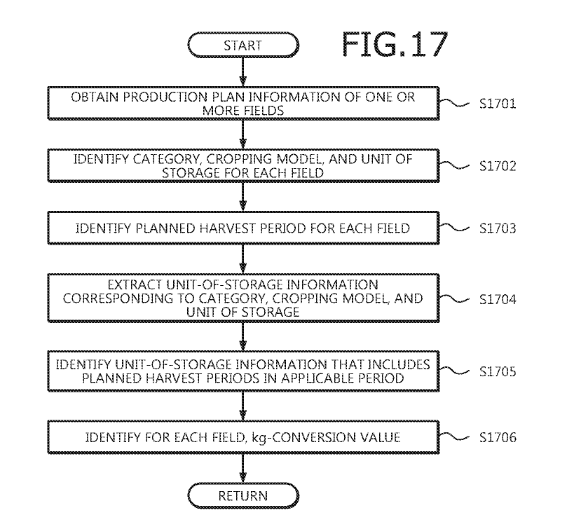

The harvest amount distributing apparatus 100 executes a conversion ratio identifying process (step S1509). The conversion ratio identifying process is a process of identifying a conversion ratio of a unit of storage and a unit of weight for the certain crop. Details of the conversion ratio identifying process will be described with reference to FIG. 17.

The harvest amount distributing apparatus 100 converts the harvest amounts distributed to the one or more fields, i.e., the distributed weight value into values indicating the harvest amounts by a unit of storage by a conversion ratio indicated by the kg-conversion values respectively identified by the conversion ratio identifying process (step S1510).

The harvest amount distributing apparatus 100 displays the harvest amount registration screen (for example, the harvest amount registration screen 1100) that associates and displays the distributed weight values and the values indicating the harvest amounts in a unit of storage, obtained by converting the distributed weight values (step S1511), and transitions to step S1601 depicted in FIG. 16.

In the flowchart depicted in FIG. 16, the harvest amount distributing apparatus 100 determines whether a change of a displayed weight value of a field has been received (step S1601). Here, if no change of a weight value has been received (step S1601: NO), the harvest amount distributing apparatus 100 transitions to step S1604.

If a change of a weight value has been received (step S1601: YES), the harvest amount distributing apparatus 100 uses a conversion ratio indicated by a kg-conversion value identified by the conversion ratio identifying process and converts the changed weight value into a value indicating the changed weight value by a unit of storage (step S1602). The harvest amount distributing apparatus 100 changes the displayed value indicating the harvest amount of the field in a unit of storage to a value indicating the changed weight value by a unit of storage, obtained by converting the changed weight value (step S1603).

The harvest amount distributing apparatus 100 determines whether a change of the displayed value indicating the harvest amount by a unit of storage has been received (step S1604). Here, if no change of the value indicating the harvest amount by a unit of storage has been received (step S1604: NO), the harvest amount distributing apparatus 100 transitions to step S1607.

If a change of the value indicating the harvest amount by a unit of storage has been received (step S1604: YES), the harvest amount distributing apparatus 100 uses the conversion ratio indicated by the kg-conversion value identified by the conversion ratio identifying process to convert the changed value indicating the harvest amount by a unit of storage into a weight value (step S1605). The harvest amount distributing apparatus 100 changes the displayed weight value of the field to a weight value obtained by converting the changed value indicating the harvest amount by a unit of storage (step S1606).

The harvest amount distributing apparatus 100 determines whether registration of harvest amounts for the certain crop has been completed (step S1607). Here, if registration of harvest amounts has not been completed (step S1607: NO), the harvest amount distributing apparatus 100 returns to step S1601.

If registration of harvest amounts has been completed (step S1607: YES), the harvest amount distributing apparatus 100 registers the harvest amount information of the one or more fields to the harvest amount table 240 (step S1608), and ends a series of operations according to the present flowchart.

Thus, the input total harvest amount of a crop may be distributed among one or more selected fields. Further, the harvest amounts distributed to the one or more fields may be converted into values indicating the harvest amounts in the respectively corresponding fields by a unit of storage.

A detailed process procedure of the conversion ratio identifying process at step S1509 depicted in FIG. 15 will be described.

FIG. 17 is a flowchart of an example of details of a process procedure of the conversion ratio identifying process. In the flowchart depicted in FIG. 17, the harvest amount distributing apparatus 100 obtains from the production plan DB 220, the production plan information of the one or more selected fields (step S1701).

The harvest amount distributing apparatus 100 refers to the obtained production plan information and identifies the category, the cropping model, and the unit of storage for each field (step S1702). The harvest amount distributing apparatus 100 refers to the obtained production plan information and identifies a planned harvest period for each field (step S1703).

The harvest amount distributing apparatus 100 extracts from the units-of-storage master 230, the unit-of-storage information corresponding to the category, the cropping model, and the unit of storage identified for each field (step S1704). The harvest amount distributing apparatus 100 identifies in the extracted unit-of-storage information, unit-of-storage information that includes the planned harvest periods of the fields in the applicable period (step S1705).

The harvest amount distributing apparatus 100 refers to the identified unit-of-storage information and identifies for each field, a kg-conversion value indicating a conversion ratio for the field (step S1706), and returns to the step calling the conversion ratio identifying process. As a result, for each field, a kg-conversion value corresponding to the category, the cropping model, the harvest period, and the unit of storage of the field may be identified.

As described, the harvest amount distributing apparatus 100 according to the embodiment enables input of the category, the harvest date, and the total harvest amount of the certain crop to be received, the production plan DB 220 to be referred to, and field information for one or more fields corresponding to the certain crop be presented on the display 406 to enable selection.

As a result, the user of the client apparatus 201 is able to identify one or more fields in which a crop of the same category as the certain crop is planted, and select one or more fields in which harvesting operations for the certain crop were performed on the input harvest date.

The harvest amount distributing apparatus 100 enables the input total harvest amount to be distributed among the selected one or more fields. For example, the harvest amount distributing apparatus 100 controls the distribution amount of the total harvest amount to be distributed to the one or more fields proportionately according to the planting areas of the one or more fields. The harvest amount distributing apparatus 100 enables the distributed harvest amounts to be displayed on the display 406 as the harvest amount of the corresponding field.

As a result, according to the planting area of the one or more fields in which the harvesting operations of the crop were performed, the total harvest amount of the crop harvested from one or more fields may be divided proportionately. Therefore, the user may identify a rough harvest amount of each field in which the certain crop is planted, which is helpful in the analysis of the cultivation efficiency, the cultivation cost, etc. for each field.

The harvest amount distributing apparatus 100 enables the harvest amounts distributed to the one or more fields, i.e., the distributed weight values to be converted into values indicating the harvest amounts in the respective corresponding fields by a unit of storage and display the values in association with the distributed weight values.

As a result, the user may evaluate the work performance of a worker who performed harvesting operations in the fields, based on values indicating the harvest amounts of the crop in a unit of storage such as boxes or containers, obtained by converting the harvest amounts (kg) distributed to the fields.

The harvest amount distributing apparatus 100 enables the distributed weight values to be converted into values indicating the distributed weight values by a unit of storage, by a conversion ratio corresponding to any one of the cropping model, the harvest date, and the planned harvest period of the crop.

As a result, with consideration of density changes consequent to differences in category, cropping model, and harvest period of the crops, for example, specific gravity of a crop according to season, a value indicating the harvest amount of the crop by a unit of weight may be converted into a value indicating the harvest amount by a unit of storage.

The harvest amount distributing apparatus 100 enables a classification of a unit having the same classification as the unit of storage specified by the production plan, to be output as the classification of the unit of storage to be displayed with the column that receives a change of input of a value indicating the harvest amount of the crop by a unit of storage.

As a result, the classification of a unit having the same classification as the unit of storage specified by the production plan may be applied as the classification of the unit of storage displayed together with the column (for example, boxes 1106, 1107 depicted in FIG. 11) that receives a change or input of a value indicated the harvest amount of the field by a unit of storage. In other words, even when the unit by which the harvest amount is counted changes according to the category of the crop or the state of the fields, a unit that is the same as the unit of storage input at the production plan stage is used in a screen for changing and inputting the harvest amount (for example, the harvest amount registration screen 1100), enabling the input and changing of a harvest amount by the user to be facilitated.

The harvest amount distributing method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

According conventional techniques, when the harvest amount in a case where a certain crop has been harvested from multiple fields is registered as a total amount of the crop harvested from the multiple fields, it may be difficult to identify the harvest amount of each field.

However, according to one aspect of the present invention, an effect is achieved in that the harvest amount of a crop harvested from one or more fields may be distributed among the fields.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A system comprising:
a first computer connected to a display; and
a second computer that includes a memory and a processor, the processor configured to
receive from the first computer, input of a harvest amount of a predetermined crop;
refer to the memory which records therein information of fields according to crop;
display on the display, the information of one or more of the fields corresponding to the predetermined crop, so as to enable selection;
distribute the input harvest amount among the one or more of the fields selected; and
display on the display, distributed harvest amounts as harvest amounts in corresponding to the fields selected.

2. A system comprising:
a first computer connected to a display; and
a second computer that includes a memory and a processor, the processor configured to
receive from the first computer, a production plan which includes a planned harvest amount of a crop to be produced; and
set a classification of a unit which has a same classification as a unit of the planned harvest amount included in the production plan, as a unit of a value indicating a harvest amount displayed on the display together with a column which receives input of the value indicating the harvest amount of the crop.

3. A harvest amount distributing method comprising:
receiving, by a computer, input of a harvest amount of a predetermined crop;
referring to a recording device recording therein information of fields according to crop, and presenting the information of one or more of the fields corresponding to the predetermined crop, so as to enable selection, the referring and presenting being performed by the computer; and
distributing the input harvest amount among the one or more of the fields selected, and recording each distributed harvest amount as a harvest amount of a corresponding field, the distributing and recording being performed by the computer.

4. The harvest amount distributing method according to claim 3, further comprising
controlling, by the computer, each distributed harvest amount for the one or more of the fields, according to planting areas of the one or more of the fields selected.

5. The harvest amount distributing method according to claim 3, further comprising
controlling, by the computer, each distributed harvest amount for the one or more of the fields to be proportional to planting areas of the one or more of the fields selected.

6. The harvest amount distributing method according to claim 3, further comprising
when a first screen displaying the harvest amount distributed to a first field of the selected one or more of the fields is output when a category of the predetermined crop and the first field match a field and category of a crop associated and recorded with a production plan,
outputting, by the computer, classification of a unit having a same classification as the unit of the harvest amount input to a second screen receiving input of the production plan, as the classification of the unit of the harvest amount displayed together with a column receiving input of the harvest amount for the category.

7. The harvest amount distributing method according to claim 6, further comprising
converting, by the computer when the output classification of the unit is not a unit of weight, the harvest amount input to the column into the unit of weight by a conversion ratio identified according to any one of a cropping model of the predetermined crop, a harvest date received via input to the first screen, and a planned harvest period associated and recorded with the predetermined crop.

8. A harvest amount input method comprising:
receiving, by a computer, a production plan including a planned harvest amount of a crop to be produced;
applying, by the computer when input of a value indicating a harvest amount of the crop is received corresponding to harvesting of the crop, classification of a unit having a same classification as a unit of the planned harvest amount included in the production plan, the classification being applied as a unit of the input value indicating the harvest amount.

9. The harvest amount input method according to claim 8, wherein
the production plan includes information of one or more fields planned for planting of the crop, and
the applying includes applying the classification of the unit having the same classification as a unit of a planned harvest amount included in the production plan, for harvest amounts of the fields, obtained by distributing the input harvest amount among the one or more fields.
